(19) United States
(12) Patent Application Publication
(10) Pub. No.: US 2026/0017081 A1
(43) Pub. Date: Jan. 15, 2026

(54) REDUCING I/O AMPLIFICATION FOR ACCESSING VM SNAPSHOTS THROUGH AN ADDITIONAL FREQUENT ACCESS STORAGE

(71) Applicant: Druva Inc., Santa Clara, CA (US)

(72) Inventors: Anand Apte, Pune (IN); Hrishikesh Pallod, Pune (IN); Uday Swami, Pune (IN); Yogendra Acharya, Pune (IN)

(21) Appl. No.: 19/096,631

(22) Filed: Mar. 31, 2025

(30) Foreign Application Priority Data
Jul. 12, 2024 (IN) 202441053298

(51) Int. Cl. G06F 9/455

(52) U.S. Cl. CPC G06F 9/45558; G06F 2009/45562

(57) ABSTRACT

A system includes a duplicative data store different from a cloud storage. The data store stores duplicative copies of data that are used by one or more virtual machines. The system receives a request to retrieve from the cloud storage data associated with a VM. The cloud storage is configured to store data in a first chunk granularity larger than a second chunk granularity of the duplicative data store. The system determines whether a duplicative copy of the requested data is stored in the data store, and responsive to determining the duplicative copy of the requested data is stored in the data store, the system retrieves the duplicative copy of requested data from the data store. The system bypasses a retrieval of the chunk from the cloud storage, and provides the duplicative copy as a response to the request.

### CROSS-REFERENCE TO RELATED APPLICATIONS

This application claims the benefit of Indian Provisional Application No. 202441053298, filed on July 12, 2024, which is incorporated by reference herein for all purposes.

### TECHNICAL FIELD

The disclosed embodiments are related to data management systems, and, more specifically, to reducing input and output requirement in accessing virtual machine snapshots on cloud storage.

### BACKGROUND

To protect against data loss, organizations may periodically back up data to a backup system and restore data from the backup system. A data management provider may provide backup services to various organizations. Input/Output (I/O) amplification is a phenomenon where the actual number of I/O operations performed by a system exceeds the number of I/O operations requested by the user or application. This issue is particularly relevant when accessing files, such as data or metadata, inside virtual machine (VM) snapshots stored on a cloud storage.

### BRIEF DESCRIPTION OF THE DRAWINGS

FIGURE(FIG.) 1A is a block diagram illustrating an example system environment, in accordance with some embodiments.

FIG. 1B is a conceptual diagram illustrating storage granularity difference among different data storages, in accordance with some embodiments.

FIG. 2 is a block diagram that illustrates an example process for building a frequent access data store, in accordance with some embodiments.

FIG. 3 is a block diagram that illustrates another example process for accessing data on a cloud storage via a frequent access data store, in accordance with some embodiments.

FIG. 4 is an example process of accessing data on a cloud storage via a frequent access data store, in accordance with some embodiments.

FIG. 5 is a block diagram illustrating components of an example computing machine, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures(FIGs.) and the following description relate to preferred embodiments by way of illustration only. One skilled in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

VM snapshots may take the form of point-in-time copies of a VM’s state, including its disk, and are crucial for quick restores and backup purposes. I/O amplification in cloud storage may be caused by the granularity of the storage system. Granularity refers to the smallest unit of data (e.g., chunk) that can be read or written in a single I/O operation. In a cloud storage, the granularity of storage operations can significantly affect performance and efficiency, especially when accessing data in VM snapshots. For instance, a cloud storage system might manage data in large chunks. When accessing or modifying data, the entire chunk may be required to be read or written, even if only a small portion of the chunk is needed. If a snapshot requires accessing small pieces of data that are scattered across different chunks, the system has to read entire chunks for each piece of data. This results in reading more data than necessary, amplifying the I/O operations.

For example, virtual machine disks are backed up with a chunk size of 1MB or 512KB typically. This enforces an upload/download granularity of the chunk size. To access data inside a backed-up virtual machine, a backup system typically issues multiple small reads of the kernel page size across the disks. For an even small amount of reads, typically the system may need to download ~20x data because of the block storage granularity constraint. Accessing metadata or data multiple times or across multiple versions of such snapshots is typically extremely inefficient because of I/O amplification. To help with this, in some embodiments, a backup system maintains the offsets and values of data on a frequent access storage. This serves two types of use-cases. First, in terms of metadata, the use of duplicative copies provides listing of data in a single VM snapshot or across multiple snapshots. Second, in terms of data, accessing specific data multiple times from a VM snapshot or different versions of the VM snapshots can become more efficient. The maintenance of this frequent access layer is controlled by signals from applications and virtual machines.

### Example System Environment

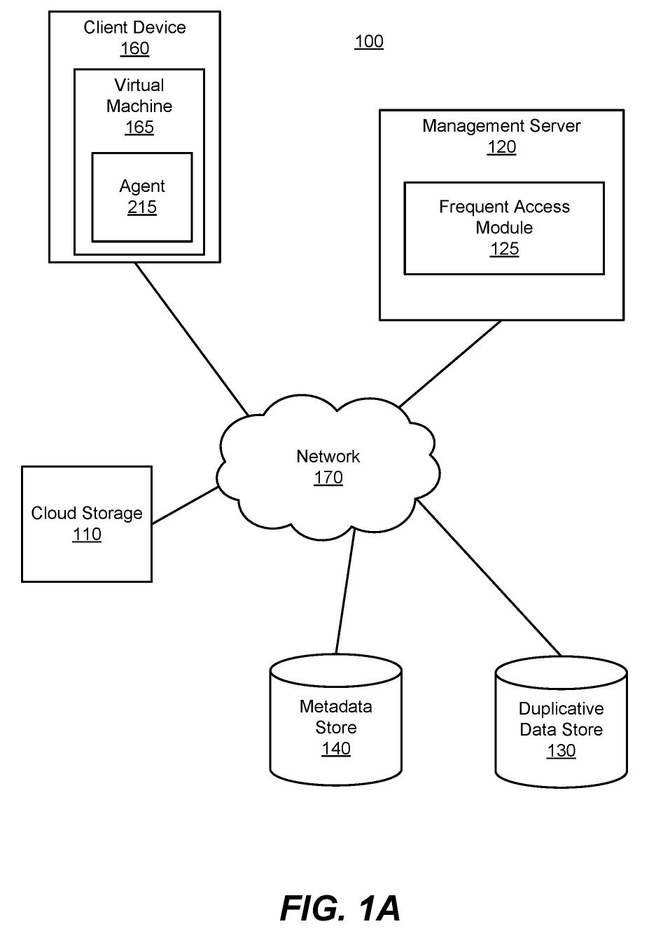

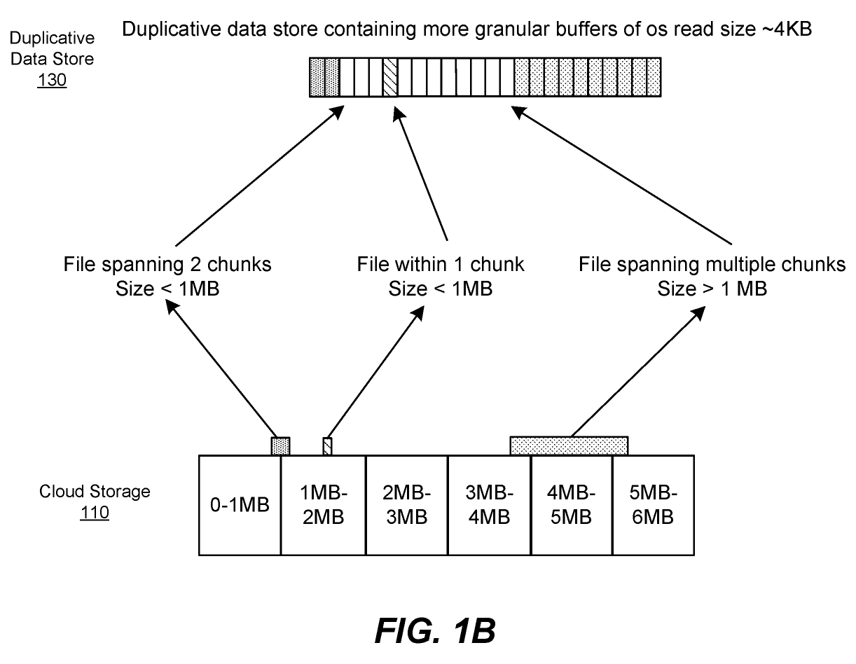

FIGURE(FIG.) 1A is a block diagram illustrating a system environment 100 of an example data management system that may be used for scheduling backup operations in a file system, in accordance with some embodiments. By way of example, the system environment 100 may include one or more cloud storages 110, a management server 120, a duplicative data store 130, a metadata store 140, a client device 160, one or more virtual machines (VMs) 165, and a network 170. In various embodiments, the system environment 100 may include fewer and additional components that are not shown in FIG. 1A.

The various components in the system environment 100 may each correspond to a separate and independent entity or some of the components may be controlled by the same entity. For example, in some embodiments, the management server 120 and the duplicative data store 130 may be controlled and operated by the same data storage provider company while the client device 160 may be controlled by an individual client. In another embodiment, the management server 120 and the duplicative data store 130 may be controlled by separate entities. For example, the management server 120 may be an entity that utilizes various popular cloud data service providers, and the duplicative data store 130 and metadata store 140 may be located on local computing devices. The components in the system environment 100 may communicate through the network 170. In some cases, some of the components in the environment 100 may also communicate through local connections. For example, the management server 120, the duplicative data store 130 and metadata store 140 may communicate locally as local servers, or may communicate remotely in the state-of-the-art Cloud storage environment.

The cloud storage 110 is configured to store and manage data in discrete units. The discrete unit may be referred to as a chunk, an object, and the like. In some embodiments, the cloud storage 110 is used to backup data from data sources, such as client devices 160. The cloud storage 110 may store snapshots of files that are used by the client devices 160. A snapshot may be a set of copies of files that reflect the state of a virtual machine (VM) run on a client device 160 and/or the state of the VM at the capture time (e.g., during a checkpoint). A snapshot may be a complete image or an incremental image of a file that is used by a VM. For example, an initial backup of a client device 160 may generate a snapshot that captures a complete image of a plurality of files used by one or more VMs run on the client device 160. Subsequent checkpoints may generate snapshots of incremental images that represent the differential changes of the files. Data in a VM may include the file data and corresponding metadata of the data.

In some embodiments, a snapshot may be divided into chunks that are saved in various different locations in the cloud storage 110. A chunk may be a set of bits that represent data of multiple files. A chunk often includes a plurality of files, such as, documents, images, data values, etc., and the associated metadata. The size of a chunk (e.g., 5 MB, 1MB, 512 KB, etc.) is often larger than the size of some files, such as system files (e.g., 10 KB) that is included in the chunk. The metadata associated with the file may include information that identifies the position within the chunk from which the file is read or written. In some implementations, files in a chunk may be identified by the identifiers of the file, such as, an external file address, data blocks’ addresses, data hash of the chunk, etc. Files from in different snapshots may include different versions, and each version is associated with a version number for identifying the corresponding version of file. In one example, a file may be identified by the offset, size, and/or version number which may be used to determine an identifier of the file. An offset is a numerical value that indicates a specific position of a file in a chunk. In some examples, the cloud storage 110 may store files that are used by one or more VMs, and one file may be used by different VMs. The metadata of a file may include an identifier indicating the file is accessible by VM1, VM3, VM8, etc. In some cases, different version of the file may be accessed by different VMs, and the associated metadata may include a mapping of the version number and the VMs, i.e., Version 1 maps to VM 3, Version 2 maps to VM 8, etc.

In some embodiments, a hashing algorithm may be used to generate the identifiers (e.g., checksum). The calculated checksum may be used as a fingerprint of the file, uniquely identifying the position and status of the file. Various individual chunk of a snapshot may be stored in different locations of a cloud storage 110 and sometimes may not be grouped. In some cloud storage 110, a file may be started in a random location based on the checksum or another identifiable fingerprint of the chunk as the address or identifier of the chunk.

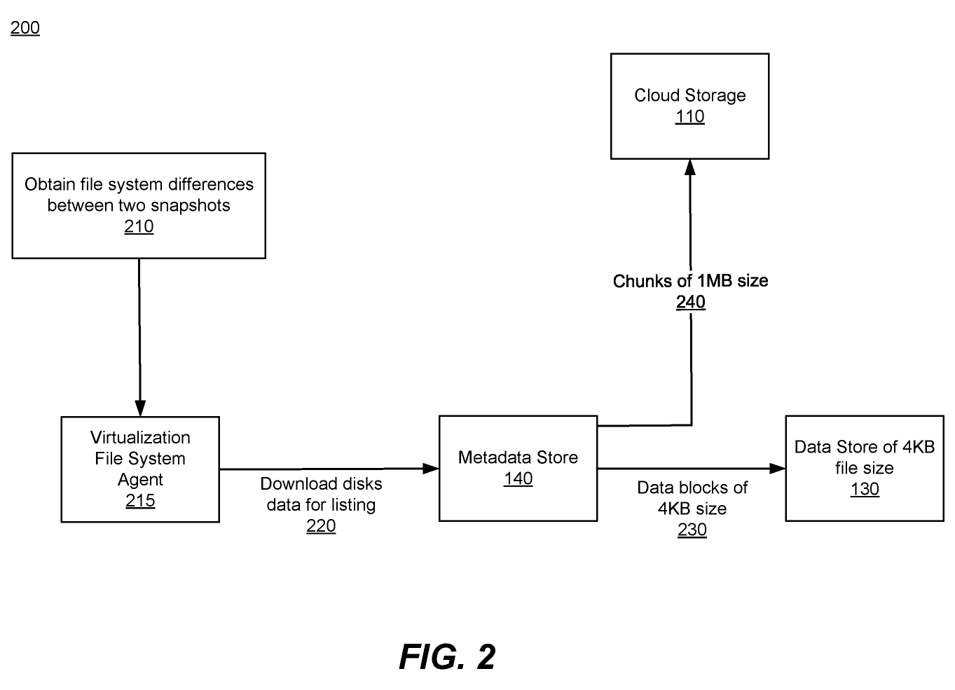

In some embodiments, the cloud storage 110 may receive a request to store, read, search, delete, modify, and/or restore data. For example, a client device 160 may send I/O (Input/Output) request for accessing data that is used by a VM. Conventionally, since the data are stored in discrete chunks in the cloud storage 110, accessing particular data requires accessing the whole chunk in which the data is included (or multiple chunks if the data or files are larger and span across multiple chunks). This results in an I/O amplification, i.e., the client device 160 is required to upload/download more data than it needs to. This disclosure provides a frequent access data store to access data that is frequently accessed by VMs via bypassing retrieval the data from cloud storage 110. Details of the frequent access data store will be further discussed in FIG. 2 through FIG. 4.

In the system environment 100, there can be different types of cloud storages. In some embodiments, the cloud storage 110 spans multiple servers, often located in various geographic locations, and the physical environment may be owned and managed by a hosting company. Examples of cloud storage service providers may include AMAZON AWS, DROPBOX, RACKSPACE CLOUD FILES, AZURE BLOB STORAGE, GOOGLE CLOUD STORAGE, etc.

In some embodiments, the cloud storage 110 may take the form of object storage. An object storage stores data in the object format in, for example, non-volatile memory. The size of an object may correspond to a chunk size and each object may also be referred to as a chunk. Examples of object storages include AMAZON S3, RACKSPACE CLOUD FILES, AZURE BLOB STORAGE, GOOGLE CLOUD STORAGE. Object storage (also known as object-based storage) is a computer data storage architecture that manages data as objects, as opposed to other storage architectures such as file storage which manages data as a file hierarchy and block storage which manages data as blocks within sectors and tracks. Each object typically may include the data of the object itself, a variable amount of metadata of the object, and a unique identifier that identifies the object. In some embodiments, a unique identifier of the object is generated based on the underlying data (e.g., generated based on the hash of the object), but this is not required for every object storage. In some embodiments, objects are created as immutable objects and the hash (e.g., checksum) of the objects is stored as part of the metadata of the objects for data integrity check. Objects may be stored in buckets and each object may be associated with the object’s data, the object’s metadata, and the object’s unique identifier. Objects may often be accessed directly from a data store and/or through API calls. This allows object storage to scale efficiently in light of various challenges in storing big data.

The management server 120 may manage data backup and restore, file retrieval, and data operation cycles (e.g., data backup cycles and restoration cycles) among one or more components such as the cloud storage 110, the client device 160, the virtual machine 165, the duplicative data store 130 and manage metadata of file systems in the duplicative data store 130, including retrieving a file that is requested by the client device 160. In some embodiments, the management server 120 may provide software platforms (e.g., online platforms), software applications that will be installed in a client device (e.g., a background backup application software), application programming interfaces (APIs) for clients to manage backup and restoration of data, etc. In some embodiments, the management server 120 manages data that is stored in the duplicative data store 130. For example, the management server 120 may coordinate the upload and download of a file among the cloud storage 110, the duplicative data store 130, the metadata store 140, and the client device 160. In this disclosure, management server 120 may collectively and singularly be referred to as a management server 120, even though the management server 120 may include more than one computing device. For example, the management server 120 may be a pool of computing devices that may be located at the same geographical location (e.g., a server room) or distributed geographically (e.g., cloud computing, distributed computing, or in a virtual server network).

A data operation cycle, such as a backup/retrieval cycle, may be triggered by an action performed at a client device 160 or a virtual machine 165 or by an event, may be scheduled as a regular cycle, or may be in response to an automated task initiated by the management server 120. In some embodiments, the client device 160 (e.g., a host machine) may run one or more VMs 165, and when running the VMs 165, the client device 160 may signal the management server 120 for requesting data from the cloud storage 110. In some embodiments, the management server 120 may poll a cloud storage 110 periodically and receive data to be backed up and corresponding metadata, such as file names, data sizes, access timestamps, access control information, and the like. In some embodiments, the management server 120 may perform incremental data operation cycles (e.g., incremental backups) that leverage data from previous data operation cycles to reduce the amount of data to store. The management server 120 may store the data of the client device as data blocks in the duplicative data store 130.

A data operation cycle, such as a backup cycle, may also include de-duplication. A de-duplication operation may include determining a fingerprint (e.g., checksum) of a file in the snapshot. For example, the fingerprint may be a hash (e.g., checksum) of the file. The management server 120 may determine that the file system has already stored a file that has the same fingerprint. In response, the management server 120 may de-duplicate the file by not downloading the file again to the duplicative data store 130. Instead, the management server 120 may create a metadata entry that links the duplicated file in the snapshot of a chunk to the file that exists in the duplicative data store 130. If the management server 120 determines that the file’s fingerprint is new, the management server 120 will cause the download of the chunk that includes the file to the duplicative data store 130.

In some embodiments, the management server 120 may also incorporate a virtualization file system agent 215 in a VM and is in control of the virtualization file system agent 215. In some embodiments, a virtualization file system agent 215 may perform various processes discussed in this disclosure.

In some embodiments, the management server 120 may capture a snapshot of files stored in the cloud storage 110 and store the files in a duplicate manner to the duplicative data store 130 in a data operation cycle. The data operation cycle may include creation of various versioning and other metadata related to a file system, the snapshots and the files involved in the data operation cycle.

In some embodiments, the management server 120 may include a frequent access module 125 to manage data that are frequently accessed by the client device 160. Frequently accessed data may refer to data that is read, written, or otherwise used often within a given period by a client device 160 (e.g., by an application run on the client device 160). Frequently accessed data may include high access rates, which is subject to frequent I/O (Input/Output) operations. The frequent access module 125 may determine data that are frequently accessed by one or more VMs that run on the client device 160 and store duplicative copies of the data in the duplicative data store 130 (e.g., a frequent data access store). The data that are stored in the duplicative data store 130 can be the file data in a VM snapshot or metadata of the files in the VM snapshot. In this way, when the client device 160 requests to access one of the one or more files, the frequent access module 125 may directly provide the duplicative copies from the duplicative data store 130 instead downloading a whole chunk containing the requested file by accessing the cloud storage 110, thus reducing the I/O amplification.

The frequent access module 125 may include a protocol to monitor and determine frequently accessed data that are used by the VMs. In some implementations, the frequent access module 125 may use a block-level filter driver for detecting the I/O requests. For example, the frequent access module 125 uses a network lock device (NBD) which intercepts I/O requests made to the cloud storage 110. These I/O requests may include read operations (downloading data from cloud storage 110) or write operations (storing data to cloud storage 110). In some embodiments, the I/O requests may include accessing listing files, reading files, reading a specific section of a specific file, etc. The frequent access module 125 may access the cloud storage 110 to locate the requested file using the metadata of the file. The frequent access module 125 downloads the whole chunk that contains the requested file from the cloud storage 110 and split the chunk into one or more files. The cloud storage 110 identifies the requested file from the one or more files and provides the requested file to the client device 160. To reduce the I/O request amplification, the frequent access module 125 may create a duplicative copy of the requested file and stores the duplicative copy to the duplicative data store 130 where frequently accessed files are stored.

In some embodiments, the frequent access module 125 may store metadata associated with the duplicative copy in the metadata store 140 and the metadata of the duplicative copy describes information of the requested file in the cloud storage 110 and/or the information of the duplicative in the duplicative data store 130. For example, the metadata may include one or more of an identifier of the file, a size of the file, an offset of the file, a version number, checksum, and a mapping between the requested data file and the duplicative copy in the duplicative data store 130. Based on the metadata, when the frequent access module 125 determines a request for accessing a frequently accessed file, the frequent access module 125 may first determine whether a duplicative copy of the requested file is stored in the duplicative data store 130. The frequent access module 125 may also use the metadata to identify the location of the duplicative copy in the duplicative data store 130 and provide the duplicative copy to the client device 160. The frequent access module 125 may use the metadata to identify changes (e.g., changes in offset or size), and update the duplicative copies in the duplicative data store 130. Details of the frequent access data store creation and management will be further discussed in FIG. 2 through FIG. 4.

In some embodiments, whether data is considered to be frequently accessed may be defined by the management server 120 or the virtual machine 165. For example, a file may be defined as frequently accessed based on its access patterns and usage metrics. In some embodiments, a file qualifies as frequently accessed if the file meets predefined criteria over a specified period, such as a minimum threshold of read or write operations, consistent access requests, or high user engagement rates. These criteria can be quantified by monitoring and recording the number of times the file is retrieved, modified, or interacted with within a designated time frame, typically on an hourly, daily, or weekly basis. Additionally, access frequency can be determined by evaluating the file’s role in critical processes or workflows, where a file integral to routine operations and exhibiting significant interaction from multiple users or systems is categorized as frequently accessed. In some embodiments, the frequently accessed criteria may be defined by the management server 120 to balance between the resources spent on maintaining a duplicative data store 130 and the I/O amplification. In some embodiments, the frequently accessed criteria may be defined by an organization (e.g., a customer of the management server 120) that controls a number of virtual machines 165. In some embodiments, the frequently accessed criteria may be specific to a client device 160 or a virtual machine 165.

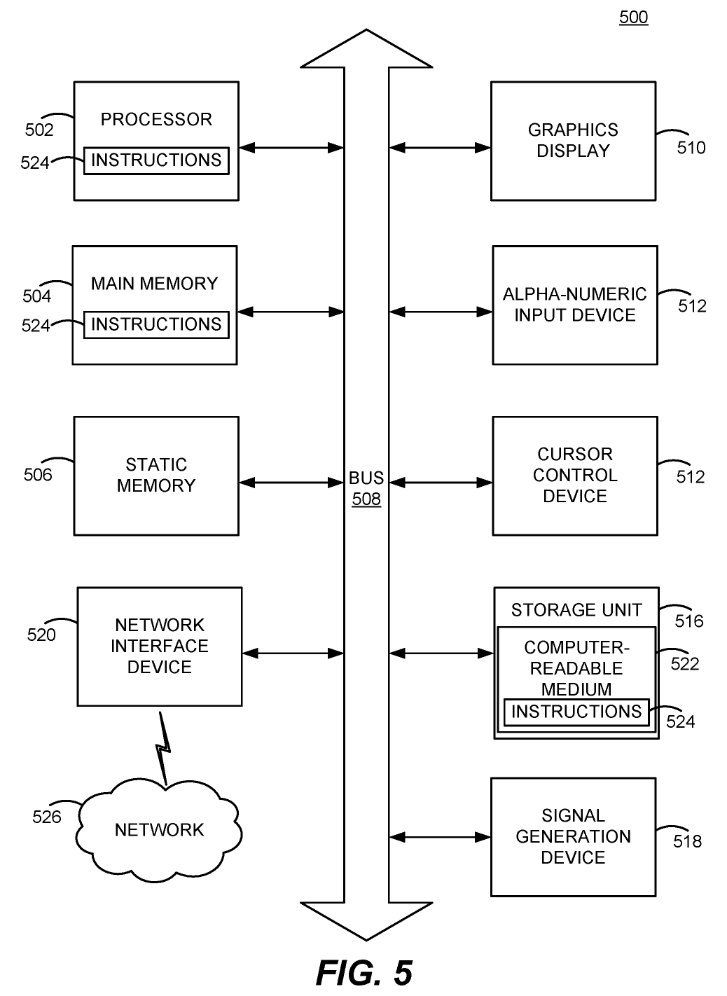

In some embodiments, a computing device of the management server 120 may take the form of software, hardware, or a combination thereof (e.g., some or all of the components of a computing machine of FIG. 5). In some embodiments, the management server 120 may operate in the Cloud and the management server 120 may include a plurality of nodes that perform various functionalities that are described in this disclosure.

The duplicative data store 130 is a data storage that is different from a cloud storage. The duplicative data store 130 may be configured to store duplicative copies of data that are used by one or more VMs. In some embodiments, the duplicative data store 130 may be a frequent access data store that stores data frequently accessed by the VMs run on the client device 160. In some embodiments, the duplicative data store 130 may communicate with the management server 120 via the network 170 for capturing and storing data from the cloud storage 110. The duplicative data store 130 may also work with the client devices 160 to cooperatively perform data management of data stored at the cloud storage 110. The duplicative data store 130 may include one or more data storage units such as memory that may take the form of non-transitory and non-volatile computer storage medium to store various data. In some embodiments, the duplicative data store 130 may also take the form of another cloud storage, but has a different chunk granularity and/or I/O requirements than the cloud storage 110. For example, the duplicative data store 130 may be a cloud storage that does not mandate a certain chunk size. The duplicative data store 130 may also run faster in terms of data storage and retrieval speed compared to the cloud storage 110. In some embodiments, a duplicative data store 130 may also take the form of an on-premise storage for an organization to store various frequently accessed data associated with the VMs of the organization. In some embodiments, the duplicative data store 130 may be a storage device that is controlled and connected to the management server 120. For example, the duplicative data store 130 may be memory (e.g., hard drives, flash memory, disks, tapes, etc.) used by the management server 120.

The duplicative data store 130 may include one or more file systems that store various data (e.g., files of used by VMs in various backups) in one or more suitable formats. For example, the duplicative data store 130 may use different data storage architectures to manage and arrange the data. A file system defines how an individual computer or system organizes its data, where the computer stores the data, and how the computer monitors where each file is located. A file system may include directories and/or addresses. The file system may also be referred to as a frequent access file system.

While in this disclosure, the duplicative data store 130 is referred to as a “duplicative” store, the duplicative data store 130 may simply be referred to as a frequent access data store. In some embodiments, a frequent access data store does not store duplicative copies. Instead, frequently accessed data are stored in the frequent access data store that has a much smaller chunk size (e.g., 4KB) while other data are stored in the cloud storage 110, which has a larger chunk size (e.g., 1MB).

The metadata store 140 may include metadata for the duplicative data store 130 in various levels, such as file system level, snapshot level, file level, and block level. Metadata is data that describes data (whether at file system level, snapshot level, and/or file level). Examples of metadata include timestamps, version identifiers, file directories including timestamps of edit or access dates, add and carry logical (ACL) checksums, journals including timestamps for change event, create version, modify version, compaction version, and delete version.

Metadata in the metadata store 140 may include usage record, snapshot records, data records, and deduplication metadata related to files that are stored in the cloud storage 110. Alternatively, the metadata store 140 may also store metadata related to files that are duplicatively stored in the duplicative data store 130. Note that deduplication is with respect to the files and data in the cloud storage 110 but not between the cloud storage 110 and the duplicative data store 130. For example, data and files may be deduplicated in the cloud storage 110 but still duplicatively stored as in the duplicative data store 130. For example, multiple end users may have the same file and file may be stored once in the cloud storage 110. Therefore, the file is dedpulicated. In addition, the management server 120 may determine that the same file is frequently accessed so that the file is duplicatively stored in the duplicative data store 130.

The file system usage record may include metadata such as a total-size counter, Uₜ, for the duplicative data store 130. The total-size counter may represent the sum of the data size in the file system. The file system usage record may include usage statistics that are stored in a database (e.g., a NoSQL) since this type of database may provide the functionality to atomically increment integer attributes. The snapshot records may include metadata of the snapshots, such as timestamps when the snapshots are captured, backup set identifiers, and increment-size counters that each represents the increase in the data size that is measured through a data operation cycle. The data records may include metadata that describes information about the files.

While the duplicative data store 130 and the metadata store 140 are illustrated as separate components in FIG. 1A, in some embodiments, the duplicative data store 130 and the metadata store 140 may be operated as the same storage. For example, in some embodiments, the duplicative data store 130 may include a file system and the metadata store 140 together as a single data store. In other embodiments, the duplicative data store 130 and the metadata store 140 are separate.

A client device 160 may be one or more computing devices whose data will need to be backed up. The client device 160 may run one or more VMs 165 which are emulations of one or more computing devices. The client device 160 may run operating system (OS) and applications. In some embodiments, the VMs run on the client device 160 may use one or more files. The VMs may store and retrieve the one or more files and associated metadata in the cloud storage 110. In one example, an application run in a VM may make an I/O request to download files from the cloud storage 110. The I/O request may include a fingerprint of the file, or specify the location (such as identifiers, offset, etc.) of the requested file. In some embodiments, the management server 120 may identify a duplicative copy of the requested file in the duplicative data store 130. The management server 120 may bypass the cloud storage 110 and provide the duplicative copy to the client device 160. Alternatively, a duplicative copy of the requested file may be not identified in the duplicative data store 130, or the duplicative copy in the duplicative data store 130 requires update. In this case, the management server 120 may have the client device 160 download the requested file from the cloud storage 110. In some embodiments, the client device 160 may upload files to the cloud storage 110, and the uploaded files may be stored in the corresponding chunks in the cloud storage 110.

The client device 160 may involve any kinds of computing devices. Examples of such computing devices include personal computers (PC), desktop computers, laptop computers, tablets (e.g., APPLE iPADs), smartphones, wearable electronic devices such as smartwatches, or any other suitable electronic devices. The data backup clients may be of different natures such as including individual end users, organizations, businesses, and other clients that use different types of client devices (e.g., target devices) that run on different operating systems. The client device 160 may take the form of software, hardware, or a combination thereof (e.g., some or all of the components of a computing machine of FIG. 5).

A virtual machine 165 may be an instance of virtualization. In some embodiments, the term virtual machine 165 is intended to be used expansive and may include various types of virtualization, including VM in the conventional sense and also other types of virtualization such as containers. A virtual machine 165 is not limited to a particular way of virtualization and may be virtualized at the hardware level, operating system level, or another level.

The communications among the cloud storage 110, the management server 120, the duplicative data store 130, metadata store 140, and/or the client device 160 may be transmitted via a network 170, for example, via the Internet. The network 170 provides connections to the components of the system environment 100 through one or more sub-networks, which may include any combination of local area and/or wide area networks, using both wired and/or wireless communication systems. In some embodiments, a network 170 uses standard communications technologies and/or protocols. For example, a network 170 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 170 may be represented using any suitable format, such as hypertext markup language (HTML), extensible markup language (XML), or JSON. In some embodiments, all or some of the communication links of a network 170 may be encrypted using any suitable technique or techniques such as secure sockets layer (SSL), transport layer security (TLS), virtual private networks (VPNs), Internet Protocol security (Ipsec), etc. The network 170 also includes links and packet switching networks such as the Internet.

While in this disclosure various systems and processes are used to improve the I/O and data retrieval of data in virtualization, the disclosure may also be applied to backing up and retrieval of data in other settings that are not related to virtualization. For example, the systems and processes may also be used to set up a duplicative data store 130 for backing up data that are stored in a cloud storage that uses a large chunk granularity. In the disclosure below, while the use of storage and retrieval of files are discussed, the storage and retrieval processes and systems may also be used for any type of data, including file data, metadata of the files, and other types of data.

FIG. 1B is a conceptual diagram illustrating the differences in storage size granularity between the cloud storage 110 and the duplicative data store 130, in accordance with some embodiments. The cloud storage 110 has a first chunk granularity (e.g., 1MB) while the duplicative data store 130 has a second chunk granularity (e.g., 4KB) that is smaller than the first chunk granularity. The files stored in the cloud storage 110 can be of any size. Some of the files are smaller than the chunk granularity of the cloud storage 110, such as the left two files illustrated in FIG. 1B. In order to retrieve the two left files from cloud storage 110, the two chunks of the total size of 2MB need to be retrieved from the cloud storage 110. However, if the two files are stored in the duplicative data store 130, only relevant smaller chunks need to be retrieved. Some files are larger than the chunk granularity of the cloud storage 110, such as the right file illustrated in FIG. 1B that span across three chunks in cloud storage 110. In order to retrieve the large file from the cloud storage 110, there is still waste in I/O because the chunks at two ends contain other data. The saving in storing frequently access data in the duplicative data store 130 improves memory usage, file retrieval speed, and data retrieval cost.

### Creation and Update of Frequent Access Data Store

FIG. 2 is a block diagram that illustrates an example process 200 for building a frequent access data store, which is an example of the duplicative data store 130, in accordance with some embodiments. The process 200 may be performed by a virtualization file system agent 215 in cooperation with management server 120. The process 200 may be embodied as a software algorithm that may be stored as computer instructions that are executable by one or more processors. The instructions, when executed by the processors, cause the processors to perform various steps in the process 200.

In some embodiments, the virtualization file system agent 215 may be an application runs as the kernel level of a virtualization and has access to file system information. For example, the virtualization file system agent 215 may take the form of a listing agent, kernel, network block device (NBD), and/or a filesystem in user space (FUSE). When a virtual machine is in use or in a backup process, the virtualization file system agent 215 may obtain 210 file system differences between two snapshots. The first snapshot may be an existing snapshot already generated, such as the snapshot in the previous backup cycle. The second snapshot may be the current snapshot. The virtualization file system agent 215 may capture the metadata associated with the files in the VM, e.g., offsets, sizes, and buffers. In some embodiments, the virtualization file system agent 215 may intercept I/O requests made to the cloud storage 110 or directly retrieve file system information.

The determination of the file system differences between two snapshots may include downloading 220 disks data for listing. For example, the virtualization file system agent 215 may perform a traversal of a folder structure for a VM. The virtualization file system agent 215 may use a block level filter driver and also observe the I/O requests during the folder structure traversal. The virtualization file system agent 215 may store the offsets, sizes, and buffers of the files in the metadata store 140 (or the duplicative data store 130). In some embodiments, the storage of the metadata is snapshot specific. For example, the virtualization file system agent 215 causes a refresh of the metadata in the metadata store 140. The previous version of the metadata corresponds to a previous snapshot. The refresh of the metadata corresponds to the current snapshot. The refresh is based on the changed blocks from snapshot to snapshot. In some embodiments, the block size in the metadata may correspond to the kernel page size.

In some embodiments, the downloading 220 of disk data may be performed as part of a list call in VM and the data downloaded is stored in the metadata store 140 as part of the metadata with respect to the particular snapshot. In some embodiments, a virtualization file system agent 215 may start with a duplicative data store 130 for the mounted logical volume of the VM. The duplicative data store 130 may serve as the primary storage provider for the VM while the cloud storage 110 may serve as the secondary storage provider. The virtualization file system agent 215 may issue a list call, such as a file system list call. The file system translates the request to read request on the block device on the virtualization file system agent 215, such as an NBD plugin, with the appropriate offsets and read sizes. Read sizes may be 3096 bytes.

The metadata store 140 may capture metadata, such as offsets, sizes, and buffers, of files in the VM. The offset indicates a specific position of a file in the cloud storage 110. The management server 120 may use the offset to pinpoint the location where data operations, such as reading or writing, should start. A size refers to the size of the file stored in the cloud storage 110. For example, a requested file may have an offset “1” and size “64 KB, thus, the data block between 1 and 64 KB in a chunk in the cloud storage 110 belongs to the requested file, and reading the requested file indicates reading the data block between 1 and 64 KB. In some embodiments, the duplicative data store 130 and the metadata store 140 may be the same data store and both data and metadata may be stored in the duplicative data store 130.

In some embodiments, the management server 120 may store at a frequent access data store (e.g., duplicative data store 130) to files that are frequently accessed by one or more VMs. The management server 120 (e.g., a frequent access module 125 of the management server 120) may provide a storage interface that allows users to create file systems (e.g., duplicative data store 130) without modifying the kernel code of the operating system (OS). The kernel of the OS handles tasks such as memory management, process scheduling, and I/O operations. The storage interface may be used to implement file systems that access remote storage (e.g., cloud storage 110), or virtual file systems (e.g., representing data in a non-traditional format) for testing and development purposes. In some implementations, the management server 120 may use the storage interface to facilitate operations such as data backup, synchronization, or system monitoring. The frequently accessed files may be stored in the chunk size (or another granularity) of 3 KBs that is significantly smaller than the chunk sizes (e.g., 1MB) of the cloud storage 110. For other files that are not frequently accessed, the files are stored in the cloud storage 110. In some embodiments, all files in the VMs are also stored in the cloud storage 110, regardless of whether a duplicative copy is stored in the duplicative data store 130. Whether a file is frequently accessed may be determined based on the metadata stored in the metadata store 140.

In one example, an application that runs on a VM may perform a folder structure traversal, and requests to access and retrieve files and directories to obtain a list of the files, e.g., downloading 220 disks data for listing as shown in FIG. 2. For example, the application makes certain request on the OS of the client device 160 for listing files. The OS may convert the request (e.g., a system call) into specific offsets and sizes that is required to render the listing file. The metadata may capture the specific offsets and sizes in the listing file and the metadata store 140 may store the offsets and sizes (e.g., metadata). A duplicative copy of the requested file in the frequent access duplicative data store 130.

In file retrieval, without using the frequent access duplicative data store 130, the client device 160 may need to download 240 a chunk of 1MB in size from the cloud storage 110 to obtain the requested file which has a much smaller size. With the frequent access duplicative data store 130, a duplicative copy of the requested file, e.g., 3KB in chunks, is stored and re-used. The client device 160 may download 230 the 3KB-sized file from the frequent access duplicative data store 130 via bypassing the retrieval from the cloud storage 110. In this way, a duplicative copy of the listing file may be stored at the frequent access duplicative data store 130 and repeated read. The duplicative copy stored at the frequent access duplicative data store 130 may be a small portion of a chunk stored in cloud storage 110, thus reducing the I/O amplification.

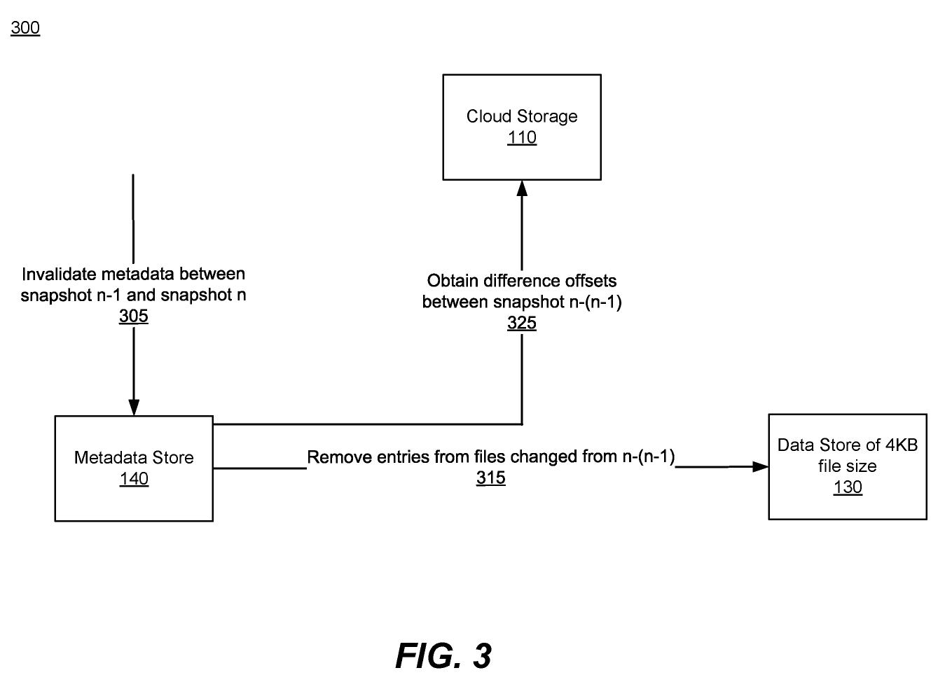

FIG. 3 is a block diagram that illustrates an example process 300 for updating a frequent access data store for incremental snapshots, in accordance with some embodiments. The process 300 may be performed by the virtualization file system agent 215 in cooperation with the metadata store 140. The process 300 may be embodied as a software algorithm that may be stored as computer instructions that are executable by one or more processors. The instructions, when executed by the processors, cause the processors to perform various steps in the process 300.

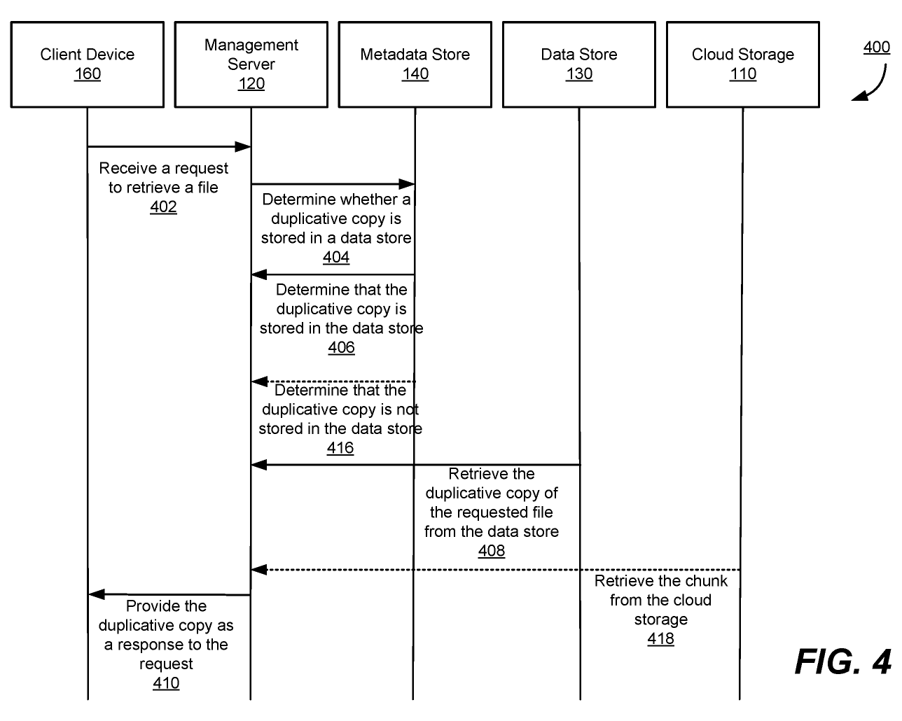

In some embodiments, a VM may run an application on incremental snapshots. At each increment snapshot, a snapshot of files that are used by the VM may be backup at the cloud storage 110. When creating a second snapshot compared to a previous snapshot, the management server 120 may determine whether there is a difference between the snapshot version “n-1” and the snapshot version “n”. For example, the virtualization file system agent 215 may issue a list call as discussed in FIG. 4 to obtain metadata in the file system and compare the new metadata to the metadata stored in the metadata store 140. In response to determining that there is no difference, no new snapshot is needed to be created. In response to the virtualization file system agent 215 determining that there is a difference, the virtualization file system agent 215 may invalidate 305 metadata stored in the metadata store 140 or mark the stored metadata as outdated or associated only with the snapshot version n-1.

In one implementation, the management server 120 may obtain the latest version of metadata and determine the changes in the metadata. The management server 120 may determine the differences in offsets of files between the two snapshots. For example, the management server 120 may use a list of changed blocks to invalidate changed offsets, eliminating the files that have been changed between two snapshots. The application may signal the frequent access data store 130 to start capturing the missing offsets and sizes. In some embodiments, the metadata store 140 may include a block map, mapping the data blocks of files in the cloud storage 110. The block map may include information such as, File 1, file identifier, “ID1”, offset “1”, size “64 KB”; and File 2, file identifier “ID2”, offset “2”, size “128KB,” etc. Each file may be associated with a fingerprint, e.g., a checksum that is calculated by using a hash function. By comparing the checksum of a file between two snapshots, the management server 120 may determine whether there is a difference in the file between the two snapshots. In some implementations, the management server 120 may obtain the latest version of files and store them to either the cloud storage 110 or the duplicative data store 130, spending on whether the files are frequently accessed. In some implementations, the management server 120 may obtain 325 the difference of the requested file between the snapshot “n” and the snapshot “n-1” from the cloud storage 110 based on the difference in the offsets. The management server 120 removes 315 entries from files changed from the snapshot “n” and the snapshot “n-1,” and store frequently accessed files the latest snapshot as duplicative copies in the frequent access duplicative data store 130. In some embodiments, the management server 120 may update the metadata associated with the requested file based on the difference in the offsets between the snapshot “n” and the snapshot “n-1,” and store the updated metadata in the metadata store 140. In some embodiments, the duplicative data store 130 may only store the frequently accessed files in the latest snapshot version and remove the frequently accessed files used in previous snapshots. In some embodiments, the duplicative data store 130 may also be versioned. The files in the VMs are backed up in the cloud storage 110.

### Retrieval of Files

FIG. 4 is an example process 400 of accessing files on a cloud storage via a frequent access data store, in accordance with some embodiments. The process 400 may be performed by the management server 120 in cooperation with the cloud storage 110, the duplicative data store 130, the metadata store 140 and the client device 160. The management server 120 may include the virtualization file system agent 215. The process 400 may be embodied as a software algorithm that may be stored as computer instructions that are executable by one or more processors. The instructions, when executed by the processors, cause the processors to perform various steps in the process 400.

A client device 160 may run one or more VMs, and an application run in one of the one or more VMs may send a request. The application may be a backup or file management application that is provided to the operating system kernel of the VM (e.g., a Linux kernel). The application may also be any suitable application in the VM. The management server 120 receives 402 a request from the client device 160. The request is to retrieve from the cloud storage 110 a file associated with a VM. The cloud storage 110 is configured to store the file in a chunk that has a size that is larger than the file and the chunk includes other files in the chunk. In some embodiments, the request is an I/O request, and the management server 120 may monitor the I/O request from the client device 160. The management server 120 may determine that the requested file is a file that is frequently accessed by one or more VMs. In some embodiments, the request may include metadata associated with the requested file. The associated metadata may include information that identifies the requested file in the cloud storage 110. For example, the metadata may include an identifier of the file, the size of the file, the offset of the file, version number, etc.

The management server 120 may determine 404 whether a duplicative copy of the requested file is stored in the duplicative data store 130. In some embodiments, the duplicative data store 130 may be a frequent access data store that stores files frequently accessed by one or more VMs. In some embodiments, the management server 120 may access the metadata store 140 which stores metadata of the duplicative copies in the duplicative data store 130. The management server 120 may use the metadata of the requested file and the metadata of the duplicative copies and determine whether a duplicative copy matches the requested file. For example, the management server 120 may compare the identifier, fingerprint, checksum, etc. between the metadata of the requested file and the metadata of the duplicative copies. The management server 120 may determine 406 that a duplicative copy of the requested file is stored in the duplicative data store 130. For example, the management server 120 may determine the metadata of the requested file to determine whether a duplicative copy of the file is stored in the duplicative data store 130. The metadata may be the file offset, the checksum of the file, and/or any appropriate metadata that may be used to uniquely identify a file.

Responsive to determining the duplicative copy of the requested file is stored in the duplicative data store 130, the management server 120 retrieves 408 the duplicative copy of requested file from the duplicative data store 130. In some embodiments, the metadata of the duplicative copy may include information that identifies the location of the duplicative file in the duplicative data store 130. For example, the metadata may include a mapping between the duplicative copies and the locations in the duplicative data store 130. The management server 120 may use the mapping to identify the location of the duplicative copy.

The management server 120 provide 410 the duplicative copy as a response to the request. Since a duplicative copy of the requested file is identified and retrievable from the duplicative data store 130, the management server 120 may bypass a retrieval of a chunk that includes the requested file from the cloud storage 110 and directly provides the duplicative copy to the client device 160 to be used by the VM, thus reducing the access to the cloud storage 110.

In some embodiments, the management server 120 may determine 416 a duplicative copy of the requested file is not stored in the duplicative data store 130. For example, the management server 120 may not identify a duplicative copy of the requested file, or the identified duplicative copy does not have the same version as the requested file (e.g., not same checksum), or the identified duplicative copy is associated with an update requirement. In this case, the management server 120 may access the requested file from the cloud storage 110. For example, the management server 120 may identify the chunk that includes the requested file in the cloud storage 110 using the metadata of the requested file. The management server 120 retrieves 418 the chunk from the cloud storage 110. The chunk may include the requested file and other files. The management server 120 may split the chunk into individual files and provide the requested file to the client device 160. In some embodiments, the management server 120 may store/update the requested file in the duplicative data store 130 and store/update the corresponding metadata in the metadata store 140.

### Computing Machine Architecture

FIG. 5 is a block diagram illustrating components of an example computing machine that is capable of reading instructions from a computer readable medium and execute them in a processor. A computer described herein may include a single computing machine shown in FIG. 5, a virtual machine, a distributed computing system that includes multiples nodes of computing machines shown in FIG. 5, or any other suitable arrangement of computing devices.

By way of example, FIG. 5 shows a diagrammatic representation of a computing machine in the example form of a computer system 500 within which instructions 524 (e.g., software, program code, or machine code), which may be stored in a computer readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 5 may correspond to any software, hardware, or combined components shown in FIGS. 1-4, including but not limited to, the cloud storage 110, the computing server 120, the duplicative data store 130, the metadata store 140 and various engines, interfaces, terminals, and machines shown in FIGS. 1-4. While FIG. 5 shows various hardware and software elements, each of the components described in FIGS. 1-4 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 524 that specify actions to be taken by that machine. Further, while only a single machine is illustrated, the term “machine” and “computer” also may be taken to include any collection of machines that individually or jointly execute instructions 524 to perform any one or more of the methodologies discussed herein.

The example computer system 500 includes one or more processors 502 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 500 also may include memory 504 that store computer code including instructions 524 that may cause the processors 502 to perform certain actions when the instructions are executed, directly or indirectly by the processors 502. Memory 504 may be any storage devices including non-volatile memory, hard drives, and other suitable storage devices. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 502 and reduces the space required for the memory 504. For example, the architecture and methods described herein reduce the complexity of the computation of the processors 502 by applying one or more novel techniques that simplify the steps generating results of the processors 502, and reduce the cost of restoring data. The algorithms described herein also reduce the storage space requirement for memory 504.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this houldd be construed to include a joint operation of multiple distributed processors.

The computer system 500 may include a main memory 504, and a static memory 506, which are configured to communicate with each other via a bus 508. The computer system 500 may further include a graphics display unit 510 (e.g., a plasma display panel (PDP), a liquid crystal display (LCD), a projector, or a cathode ray tube (CRT)). The graphics display unit 510, controlled by the processors 502, displays a graphical user interface (GUI) to display one or more results and data generated by the processes described herein. The computer system 500 also may include alphanumeric input device 512 (e.g., a keyboard), a cursor control device 514 (e.g., a mouse, a trackball, a joystick, a motion sensor, or other pointing instrument), a storage unit 516 (a hard drive, a solid state drive, a hybrid drive, a memory disk, etc.), a signal generation device 518 (e.g., a speaker), and a network interface device 520, which also are configured to communicate via the bus 508.

The storage unit 516 includes a computer readable medium 522 on which is stored instructions 524 embodying any one or more of the methodologies or functions described herein. The instructions 524 also may reside, completely or at least partially, within the main memory 504 or within the processor 502 (e.g., within a processor’s cache memory) during execution thereof by the computer system 500, the main memory 504 and the processor 502 also constituting computer readable media. The instructions 524 may be transmitted or received over a network 526 via the network interface device 520.

While computer readable medium 522 is shown in an example embodiment to be a single medium, the term “computer readable medium” should be taken to include a single medium or multiple media (e.g., a centralized or distributed database, or associated caches and servers) able to store instructions (e.g., instructions 524). The computer readable medium may include any medium that is capable of storing instructions (e.g., instructions 524) for execution by the processors (e.g., processors 502) and that causes the processors to perform any one or more of the methodologies disclosed herein. The computer readable medium may include, but not be limited to, data repositories in the form of solid-state memories, optical media, and magnetic media. The computer readable medium does not include a transitory medium such as a propagating signal or a carrier wave.

### Additional Considerations

Beneficially, various processes described in this disclosure provide advantages in a backup system. The processes identify metadata blocks and store them in fast storage tier, to support data or metadata related use cases e.g., traversal, finding diffs, reading specific files, etc. For example, incremental versions of these blocks can be stored in space efficient way. The processes also provide easy and efficient mechanism to identify and collect the metadata blocks from backed up image. This can be done as part of file traversal. The processes also provide an efficient mechanism to identify differences in data blocks after incremental backup. The processes may provide various use cases in data backup. For example, the processes may provide indexing of files across snapshots of VMs. Second, the system may allow listing/traversal for file/folders, for latest snapshot as well as older snapshots, without interacting with the cloud storage 110 because of the metadata stored in the metadata store 140. Third, the system may also generate differences for each snapshot (list of file/ folder changes since last snapshot). Fourth, the system allows any other analytics use cases based on metadata. Fifth, the system provide access of specific files from the same snapshot or multiple snapshots.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A system, comprising:
a duplicative data store different from a cloud storage, the duplicative data store configured to store duplicative copies of data that are used by one or more virtual machines (VMs); and
a virtualization agent in communication with the duplicative data store and the cloud storage, the virtualization agent is associated with one or more processors and memory configured to store code comprising instructions, wherein the instructions, when executed by the one or more processors, cause the one or more processors to:
receive a request to retrieve, from the cloud storage, data associated with a VM, wherein the cloud storage is configured to store data in a first chunk granularity larger than a second chunk granularity of the duplicative data store;
determine whether a duplicative copy of the requested data is stored in the duplicative data store;
responsive to determining the duplicative copy of the requested data is stored in the duplicative data store, retrieve the duplicative copy of requested data from the duplicative data store;
bypass a retrieval of the chunk from the cloud storage; and
provide the duplicative copy as a response to the request.

2. The system of claim 1, wherein the instructions to determine whether a duplicative copy of the requested data is stored in the duplicative data store, cause the one or more processors to:
identify metadata associated with the requested data in a metadata store.

3. The system of claim 2, wherein the metadata associated with the requested data comprises an offset and a size of data block, and the instructions to identify metadata associated with the requested data, cause the one or more processors to:
determine a fingerprint of the duplicative copy stored in the duplicative data store;
compare the fingerprint of the duplicative copy with the fingerprint of the requested data; and
responsive to the fingerprint of the duplicative copy matching the fingerprint of the requested data, determine the requested data is stored in the duplicative data store.

4. The system of claim 2, wherein the metadata associated with the requested data comprises an offset and a size of the requested data for identifying the requested data in the cloud storage.

5. The system of claim 1, wherein the instructions, when executed by the one or more processors, further cause the one or more processors to:
receive a second request to retrieve from the cloud storage second data associated with the VM;
determine that the second requested data is not stored in the duplicative data store;
retrieve a second chunk from the cloud storage, the second chunk comprises the second requested data and other data; and
store a duplicative copy of the second requested data in the duplicative data store.

6. The system of claim 5, wherein the instructions to store a duplicative copy of the second requested data in the duplicative data store, cause the one or more processors to:
split the second chunk into a set of files, at least one of the set of files is the requested second data; and
store, in the duplicative data store, the at least one file as the duplicative copy of the second requested data.

7. The system of claim 1, wherein the requested data comprises a set of different versions, each identified by a version number.

8. A computer-implemented method, comprising:
receiving a request to retrieve, from a cloud storage, data associated with a VM, wherein the cloud storage is configured to store data in a first chunk granularity larger than a second chunk granularity of the duplicative data store;
determining whether a duplicative copy of the requested data is stored in a duplicative data store, wherein the duplicative data store is different from the cloud storage and is configured to store duplicative copies of data that are used by one or more virtual machines (VMs);
responsive to determining the duplicative copy of the requested data is stored in the duplicative data store, retrieving the duplicative copy of requested data from the duplicative data store;
bypassing a retrieval of the chunk from the cloud storage; and
providing the duplicative copy as a response to the request.

9. The computer-implemented method of claim 8, wherein demining whether a duplicative copy of the requested data is stored in the duplicative data store comprises:
identifying metadata associated with the requested data in a metadata store.

10. The computer-implemented method of claim 9, wherein the metadata associated with the requested data comprises an offset and a size of data block, and identifying metadata associated with the requested data comprises:
determining a fingerprint of the duplicative copy stored in the duplicative data store;
comparing the fingerprint of the duplicative copy with the fingerprint of the requested data; and
responsive to the fingerprint of the duplicative copy matching the fingerprint of the requested data, determining the requested data is stored in the duplicative data store.

11. The computer-implemented method of claim 9, wherein the metadata associated with the requested data comprises an offset and a size of the requested data for identifying the requested data in the cloud storage.

12. The computer-implemented method of claim 8, further comprising:
receiving a second request to retrieve from the cloud storage second data associated with the VM;
determining that the second requested data is not stored in the duplicative data store;
retrieving a second chunk from the cloud storage, the second chunk comprises the second requested data and other data; and
storing a duplicative copy of the second requested data in the duplicative data store.

13. The computer-implemented method of claim 12, wherein storing a duplicative copy of the second requested data in the duplicative data store comprises:
splitting the second chunk into a set of files, at least one of the set of files is the requested second data; and
storing, the second chunk into a set of files, at least one of the set of files is the requested second data.

14. The computer-implemented method of claim 8, wherein the requested data comprises a set of different versions, each identified by a version number.

15. A non-transitory computer readable storage medium comprising stored program code, the program code comprising instructions, the instructions when executed causes a processor system to:
receive a request to retrieve from, a cloud storage, data associated with a VM, wherein the cloud storage is configured to store data in a first chunk granularity larger than a second chunk granularity of the duplicative data store;
determine whether a duplicative copy of the requested data is stored in a duplicative data store, wherein the duplicative data store is different from the cloud storage and is configured to store duplicative copies of data that are used by one or more virtual machines (VMs);
responsive to determining the duplicative copy of the requested data is stored in the duplicative data store, retrieve the duplicative copy of requested data from the duplicative data store;
bypass a retrieval of the chunk from the cloud storage; and
provide the duplicative copy as a response to the request.

16. The non-transitory computer readable storage medium of claim 15, wherein the instructions to determine whether a duplicative copy of the requested data is stored in the duplicative data store, cause the processor system to:
identify metadata associated with the requested data in a metadata store.

17. The non-transitory computer readable storage medium of claim 16, wherein the metadata associated with the requested data comprises an offset and a size of data block, and the instructions to identify metadata associated with the requested data, cause the processor system to:
determine a fingerprint of the duplicative copy stored in the duplicative data store;
compare the fingerprint of the duplicative copy with the fingerprint of the requested data; and
responsive to the fingerprint of the duplicative copy matching the fingerprint of the requested data, determine the requested data is stored in the duplicative data store.

18. The non-transitory computer readable storage medium of claim 16, wherein the metadata associated with the requested data comprises an offset and a size of the requested data for identifying the requested data in the cloud storage.

19. The non-transitory computer readable storage medium of claim 15, wherein the instructions, when executed by the one or more processors, further cause the processor system to:
receive a second request to retrieve from the cloud storage second data associated with the VM;
determine that the second requested data is not stored in the duplicative data store;
retrieve a second chunk from the cloud storage, the second chunk comprises the second requested data and other data; and
store a duplicative copy of the second requested data in the duplicative data store.

20. The non-transitory computer readable storage medium of claim 19, wherein the instructions to store a duplicative copy of the second requested data in the duplicative data store, cause the processor system to:
split the second chunk into a set of files, at least one of the set of files is the requested second data; and
store, the second chunk into a set of files, at least one of the set of files is the requested second data.
